(19) United States
(12) Patent Application Publication
(10) Pub. No.: US 2005/0049016 A1
(43) Pub. Date: Mar. 3, 2005

(54) Port cover unit for electronic equipment

(75) Inventors: Bum-Lai Cho, Suwon-si (KR); Hong-Bae Kim, Yongin-si (KR); Kwang-Su Seo, Yongin-si (KR); Hong-Moon Chun, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/923,401

(22) Filed: Aug. 20, 2004

(30) Foreign Application Priority Data
Aug. 25, 2003 (KR) 58772/2003
Dec. 27, 2003 (KR) 98073/2003

(51) Int. Cl. H04M 1/00; H04B 1/38

(52) U.S. Cl. 455/575.1; 455/575.8; 455/557

(57) ABSTRACT

A port cover unit located on a preferred region of an electronic component for protecting various ports exposed at the outside of the component. The port cover unit includes a cover housing, a sliding cover slidably attached to an upper end of the cover housing for partially opening or closing the cover housing, and a stationary cover attached to the upper end of the cover housing. The stationary cover is aligned with the sliding cover or is placed below the sliding cover depending on the position of the sliding cover. The port cover unit can be easily made utilizing the injection molding, whereby aesthetic appearance of the port cover unit is improved.

### PRIORITY

This application claims priority to an application entitled “PORT COVER UNIT FOR ELECTRONIC EQUIPMENT”, filed in the Korean Intellectual Property Office on Aug. 25, 2003 and assigned Serial No. 2003-58773, and to an application entitled “PORT COVER UNIT FOR ELECTRONIC EQUIPMENT”, filed in the Korean Intellectual Property Office on Dec. 27, 2003 and assigned Serial No. 2003-98073, the contents of both of which are incorporated herein by reference.

### BACKGROUND OF THE INVENTION

1. Field of the Invention

The present invention relates generally to electronic equipment including a portable communication terminal, and more particularly to a cover unit for covering ports of various electronic equipments.

2. Description of the Related Art

In general, “portable communication terminals” are devices that are portable and enable owners of the devices to communicate in a wireless way. The portable communication terminals may be classified into several types of communication terminals based on their external appearances. For example, the portable communication terminals may be classified into a bar-type communication terminal, a flip-type communication terminal, and a folder-type communication terminal. The bar-type communication terminal has a bar-type single housing, the flip-type communication terminal includes a bar-type housing and a flip part pivotably attached to the housing, and the folder-type communication terminal includes a bar-type housing and a folder part pivotably attached to the housing.

Additionally, portable communication terminals may be classified into a necklace-type communication terminal and a wrist-type communication terminal based on a position or way in which a user puts it on. The necklace-type communication terminal is worn on the neck of a user using a string, and the wrist-type communication terminal is worn around the wrist of the user.

Further, portable communication terminals may be classified into a rotation-type communication terminal and a sliding-type communication terminal based on the method of opening and closing the device. In the case of the rotation-type communication terminal, two housings are rotatably connected to each other when the housings face opposite to each other. The rotation-type communication terminal is opened or closed by the rotation of the two housings, thus the housings are rotated apart from or close to each other. In the case of the sliding-type communication device, two housings are longitudinally slid. The sliding-type communication terminal is opened or closed by the sliding movement of the two housings, thus the housings are slid apart from or close to each other. The above described various types of communication terminals are easily understood by a person having an ordinary skill in the art to which the present invention pertains.

Such portable communication terminals are equipped with various ports, which are provided for connecting with information processing devices, such as personal computers or peripheral devices. For example, the ports may include USB ports for connecting with personal computers, interface connectors for connecting with portable chargers, and ear-microphone jacks for connecting with ear-microphones. The ports are provided at the lower end or the side of the portable communication terminal. The ports are generally protected by covers, preferably made of rubber.

However, the conventional portable communication terminal has lack of aesthetic appearance because the cover for protecting the port of the portable communication terminal is made of rubber. The rubber used in the conventional portable communication terminal is quite different from an injection-molded material used for the portable communication terminal itself, although it is provided at the outer side of the portable communication terminal when being exposed at the outside. Furthermore, the cover is usually opened with the fingernail of a user, which may cause inconvenience for the user.

### SUMMARY OF THE INVENTION

Therefore, the present invention has been made in view of the above problem, and it is an object of the present invention to provide a port cover unit for portable communication terminals, which can be made preferably utilizing injection molding.

It is another object of the present invention to provide a port cover unit for portable communication terminals, which can be easily opened or closed.

It is yet another object of the present invention to provide a port cover unit for portable communication terminals having an elastic member, by which a port cover is easily opened and closed.

It is still another object of the present invention to provide a port cover unit for portable communication terminals having a port cover that can be slidably moved or rotated.

In accordance with an aspect of the present invention, the above and other objects and advantages can be accomplished by the provision of a port cover unit located at a preferred region on electronic equipment for protecting various ports exposed at the outside of the electronic equipment. The port cover unit includes a cover housing positioned on the port of the electronic equipment and opened in the upper and lower directions for exposing the port to the outside of the electronic equipment, a sliding cover slidably attached to an upper end of the cover housing and moved in the longitudinal direction of the cover housing for partially opening or closing the cover housing, and a stationary cover attached to the upper end of the cover housing, the stationary cover aligned with the sliding cover or placed below the sliding cover depending on the position of the sliding cover.

In accordance with another aspect of the present invention, a port cover unit is mounted to a predetermined region of an electronic component for protecting various ports exposed to an outside of the electronic component, the port cover unit including: a mounting groove formed at a predetermined region of the electronic component, the mounting groove being provided at an inside thereof with a port hole; a sliding cover disposed in the mounting groove, the sliding cover being slidably moved upward and downward in the longitudinal direction of the mounting groove for opening and closing the port hole; a stationary cover disposed at a bottom part of the sliding cover, the stationary cover being aligned with the sliding cover and placed below the sliding cover as the sliding cover is moved; and an elastic member disposed at a rear of the stationary cover for providing an elastic force for supporting the stationary cover when the stationary cover is aligned with the sliding cover or placed below the sliding cover.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a portable communication terminal to which a port cover unit according to a preferred embodiment of the present invention is mounted;

FIG. 2 is an exploded perspective view of the port cover unit shown in FIG. 1;

FIG. 3 is an enlarged perspective view of the port cover unit shown in FIG. 1 with the port closed;

FIG. 4 is an enlarged perspective view of the port cover shown in FIG. 1 with the port opened;

FIG. 5 is a longitudinal cross-sectional view of the port cover unit shown in FIG. 3;

FIG. 6 is a longitudinal cross-sectional view of the port cover unit shown in FIG. 5;

FIG. 7 is an exploded perspective view illustrating the construction of a port cover unit according to a second preferred embodiment of the present invention;

FIG. 8 is an enlarged perspective view of the encircled portion A of FIG. 7;

FIG. 9 is a partially enlarged plan view illustrating a mounting groove of the port cover unit according to the second preferred embodiment of the present invention;

FIG. 10 is a perspective view illustrating the assembly of the port cover unit according to the second preferred embodiment of the present invention;

FIG. 11 is an enlarged perspective view of the encircled portion B of FIG. 10;

FIG. 12 is a perspective view illustrating the use of the port cover unit according to the second preferred embodiment of the present invention;

FIG. 13 is a partially enlarged perspective view of FIG. 12;

FIG. 14 is a side cross-sectional view illustrating a sliding cover of the port cover unit according to the second preferred embodiment of the present invention before the sliding cover is slid;

FIG. 15 is a side cross-sectional view illustrating the sliding cover of the port cover unit according to the second preferred embodiment of the present invention after the sliding cover is slid;

FIG. 16 is a perspective view illustrating a curved portable communication terminal to which the port cover unit according to the second preferred embodiment of the present invention is mounted, when the sliding cover is closed; and

FIG. 17 is a perspective view illustrating the curved portable communication terminal with the port cover unit of FIG. 16 mounted, after the sliding cover is opened.

### DETAILED DESCRIPTION OF THE PREFERRED EMBODIMENTS

A preferred embodiment of the present invention will be described in detail with reference to the accompanying drawings. In the drawings, the same or similar elements are denoted by the same reference numerals even though they are depicted in different drawings. In the following, a detailed description of known functions and configurations incorporated herein will be omitted for clarity where they are well known in the art.

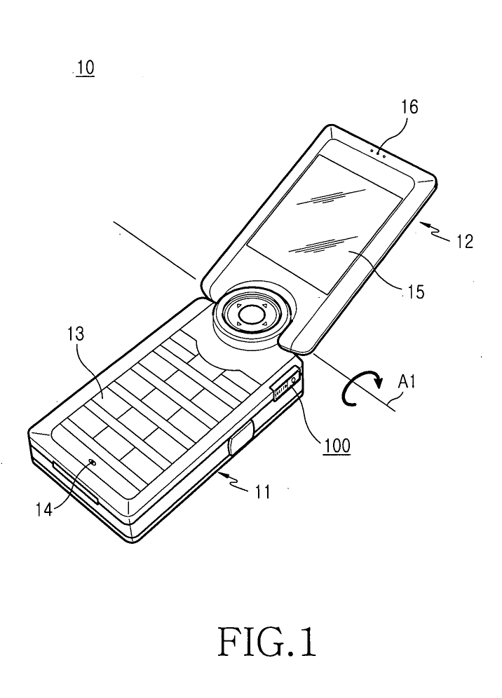

FIG. 1 is a perspective view illustrating a portable communication terminal 10 to which a port cover unit 100, to which the preferred embodiment of the present invention is applied. As shown in FIG. 1, the port cover unit 100 is situated on a port (not shown), such as an ear-microphone jack, of the portable communication terminal 10.

The portable communication terminal 10 includes a main body 11 including a keypad 13 which is a data input unit, a microphone 14 formed thereon, a folder part 12 including a display unit 15 which is a data output unit, and a speaker phone 16 formed thereon. The folder part 12 is rotatably attached to the main body 11 of the portable communication terminal 10 by a hinge unit (not shown), thus the folder part 12 is located on top of the main body 10.

The port cover unit 100 is positioned to a side of the main body 11, which is preferably located close to an upper end of the portable communication terminal 10. An ordinary ear-microphone jack is provided preferably near the upper end of the main body 11 of the portable communication terminal 10. Specifically, the ear-microphone jack is provided at a rear part or the side of the main body 11. Referring to FIG. 1, the ear-microphone jack is provided at the side of the main body 11, and the port cover unit 100 is positioned to the side of the main body 11 corresponding to the ear-microphone jack.

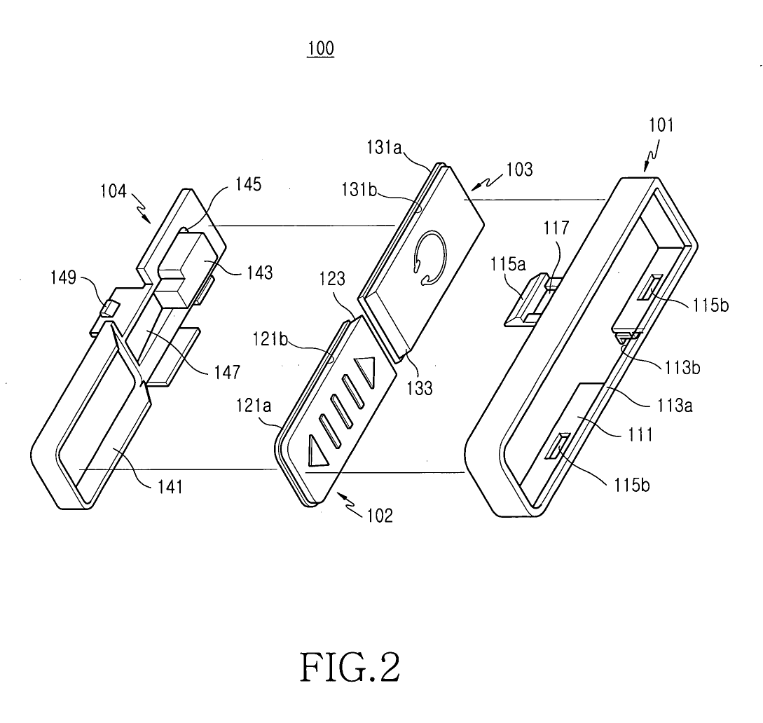

FIG. 2 is an exploded perspective view of the port cover unit 100 located on the portable communication terminal 10 shown in FIG. 1. As shown in FIG. 2, the port cover unit 100 of the present invention includes a cover housing 101, a sliding cover 102, a stationary cover 103, and a cover base 104.

The cover housing 101 is positioned to one side of the main body 11 of the portable communication terminal 10. The cover housing 101 has a sidewall 111 extending in the longitudinal direction of the main body 11 and opened in the upper and lower directions. The sidewall 111 is provided at the upper inside part thereof with a first guide rib 113a, which protrudes toward an inside of the sidewall 111 by a predetermined length. The first guide rib 113a guides the movement of the sliding cover 102 when it prevents the sliding cover 102 and the stationary cover 103 from separating from the cover housing 101. At the sidewall 111 of the cover housing 101 are formed a coupling piece 115a for coupling with the main body 11 or the cover base 104, and two first coupling holes 115b. At the coupling piece 115a is also formed a second coupling hole 117. The coupling piece 115a or the coupling holes 115b and 117 are formed corresponding to coupling protrusions 149 formed at the cover base 104. Consequently, the cover housing 101 and the cover base 104 are coupled with each other.

The sliding cover 102 is slidably moved in the longitudinal direction of the main body 11 when being guided using the first guide rib 113a of the cover housing 101. The sliding cover 102 is provided at the lower outside part thereof with a second guide rib 121a. The sliding cover 102 is slidably moved in the cover housing 101 when a first step-shaped portion 113b formed at the first guide rib 113a is located in contact with a second step-shaped portion 121b formed at the second guide rib 121a. As the sliding cover 102 is slidably moved in the cover housing 101, the cover housing 101 is partially opened or closed. When the cover housing 101 is partially opened by sliding cover 102, the port of the portable communication terminal, for example, the ear-microphone jack is exposed to the outside. On the top surface of the sliding cover 102 may be formed protrusions of preferred shapes, therefore a user can easily move the sliding cover 102.

The stationary cover 103 is aligned with the sliding cover 102 when the cover housing 101 is closed by the sliding cover 102. The stationary cover 103 is moved vertically in the cover housing 101 by a predetermined height. The stationary cover 103 is provided at the lower outside part thereof with a third guide rib 131a. A third step-shaped portion 131b formed at the third guide rib 131a is engaged with the first step-shaped portion 113b formed at the first guide rib 113a. Consequently, the stationary cover 103 is not separated from the cover housing 101.

The sliding cover 102 has a first inclined surface 123 formed at an end thereof. Similarly, the stationary cover 103 has a second inclined surface 133 formed at an end thereof. The first and second inclined surfaces 123 and 133 are opposite to each other. When the sliding cover 102 is aligned with the stationary cover 103, the first inclined surface 123 fully contacts with the second inclined surface 133 when the first inclined surface 123 is placed on the second inclined surface 133. When the sliding cover 102 is slidably moved, the sliding cover 102 is moved to an end of the cover housing 101 along the second inclined surface 133 of the stationary cover 103, thus the sliding cover 102 is placed on the top surface of the stationary cover 103. In other words, the stationary cover 103 is placed below the sliding cover 102 when the sliding cover 102 is moved to the end of the cover housing 101 where the stationary cover 103 is disposed.

The sliding cover 102 and the stationary cover 103 are placed inside the first guide rib 113a of the cover housing 101. The sliding cover 102 and the stationary cover 103 are provided with the second guide rib 121a and the third guide rib 131a, respectively, by which the sliding cover 102 and the stationary cover 103 are placed at the upper end of the cover housing 101. As the sliding cover 102 is slidably moved in the cover housing 101, the port of the portable communication terminal 10 is exposed to the outside or hidden from the outside. When the cover housing 101 is closed, the sliding cover 102 is aligned with the stationary cover 103, thus the covers 102 and 103 are flush with the outer surface of the portable communication terminal 10.

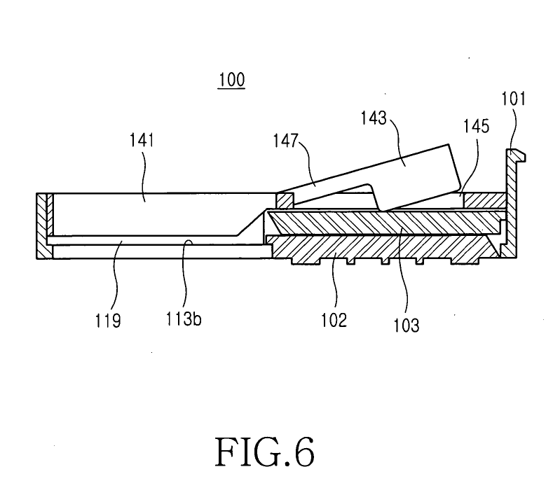

The cover base 104 is attached to a lower end of the cover housing 101. The cover base 104 is provided at a side thereof with a first opening 141, which communicates with a space defined by the sidewall 111 of the cover housing 101. The cover base 104 is also provided at the other side thereof with a second opening 145, which longitudinally extends from a preferred position. The first opening 141 communicates with the space of the cover housing 101 closed by the sliding cover 102. As the sliding cover 102 is slidably moved in the cover housing 101, the first opening 141 of the cover base 104 is opened. Consequently, the ear-microphone jack of the portable communication terminal 10 is exposed to the outside through the first opening 141. Between the cover base 104 and the first guide rib 113a of the cover housing 101 is formed a linear groove 119 (See FIG. 6), along which the second guide rib 121a of the sliding cover 102 is moved. To an end of the second opening 145, which is located preferably closer to the first opening 141, is attached an elastic piece 147, which extends longitudinally. The elastic piece 147 has a supporting member 143 formed at the end thereof. The supporting member 143 provides the elastic force applied to the stationary cover 103. Consequently, when the stationary cover 103 is placed below the sliding cover 102, the supporting member 143 is retracted, thus an elastic force is accumulated in the elastic piece 147. When the sliding cover 102 is slidably moved to close the cover housing 101, the supporting member 143 is moved to the upper end of the cover housing 101 using the elastic force accumulated in the elastic piece 147. Consequently, the stationary cover 103 is placed at the upper end of the cover housing 101.

The cover base 104 is provided at the outside thereof with one or more of coupling protrusion 149, which is engaged in the corresponding coupling holes 115b and 117. Therefore, the cover housing 101 and the cover base 104 are coupled with each other.

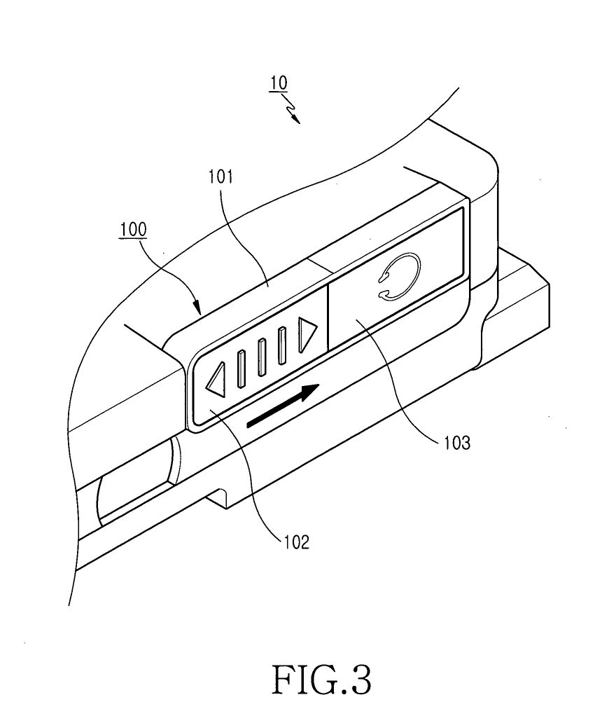

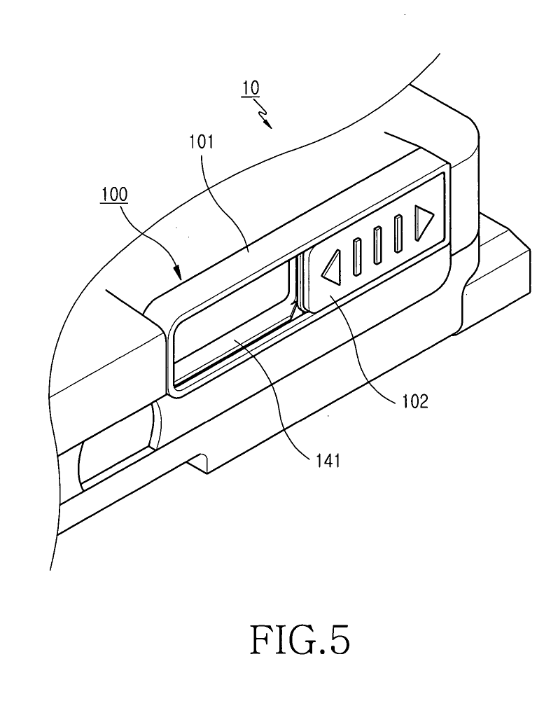

FIG. 3 is an enlarged perspective view of the port cover unit 100 shown in FIG. 1 with the port closed, and FIG. 5 is a longitudinal cross-sectional view of the port cover unit 100 shown in FIG. 3. When the sliding cover 102 of the port cover unit 100 is placed in such a manner that the cover housing 101 is closed by the sliding cover 102 as shown in FIGS. 3 and 5, the sliding cover 102 is aligned with the stationary cover 103 at the upper end of the cover housing 101. Consequently, the outer surfaces of the sliding cover 102 and the stationary cover 103 are flush with the outer surfaces of the cover housing 101 and the portable communication terminal 10. The supporting member 143 illustrated in FIG. 5 supports the lower surface of the stationary cover 103. At this time, a prescribed amount of the elastic force is accumulated in the elastic piece 147, which ensures that the outer surface of the stationary cover 103 is flush with the outer surface of the cover housing 101.

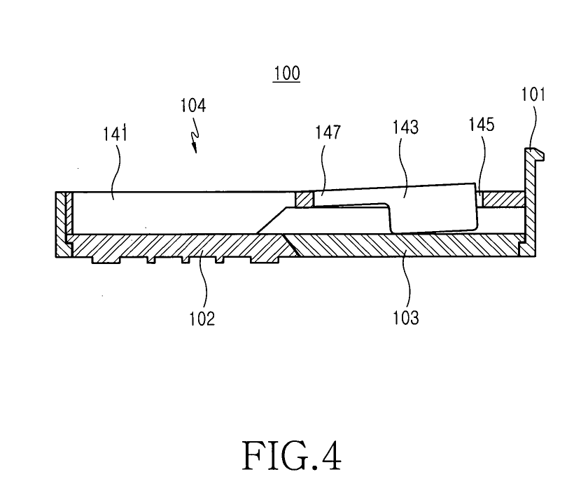

FIG. 4 is an enlarged perspective view of the port cover 100 shown in FIG. 1 with the port opened, and FIG. 6 is a longitudinal cross-sectional view of the port cover unit 100 shown in FIG. 4. As shown in FIGS. 4 and 6, the sliding cover 102 is slidably moved in the direction indicated by an arrow (See FIG. 3), thus the cover housing 101 is partially opened. The stationary cover 103 is placed below the sliding cover 102. As the cover housing 101 is partially opened by placing the sliding cover 102 on the top of the stationary cover 103, the first opening 141 of the cover base 104 is also opened. At this time, the outer surface of the sliding cover 102 is flush with the outer surface of the cover housing 101, and the stationary cover 103 is placed below the sliding cover 102. Consequently, the stationary cover 103 is moved inwardly into the inside of the cover housing 101 by a predetermined depth. The supporting member 143 is retracted by the stationary cover 103, thus the elastic force is accumulated in the elastic piece 147. The elastic force is applied to the stationary cover 103, thus the stationary cover 103 pushes the sliding cover 102. Consequently, the sliding cover 102 is placed at the upped end of the cover housing 101. Consequently, the outer surface of the sliding cover 102 is flush with the outer surface of the cover housing 101 although the sliding cover 102 is placed on the top of the stationary cover 103.

The port cover unit 100 of the portable communication terminal 10 can be easily opened or closed because the sliding cover 102 is moved in a desired direction by gently pushing the sliding cover 102 when the sliding cover 102 is slightly depressed. Consequently, the port cover unit 100 of the present invention is conveniently used. Also, the port cover unit 100 can be made preferably utilizing injection molding.

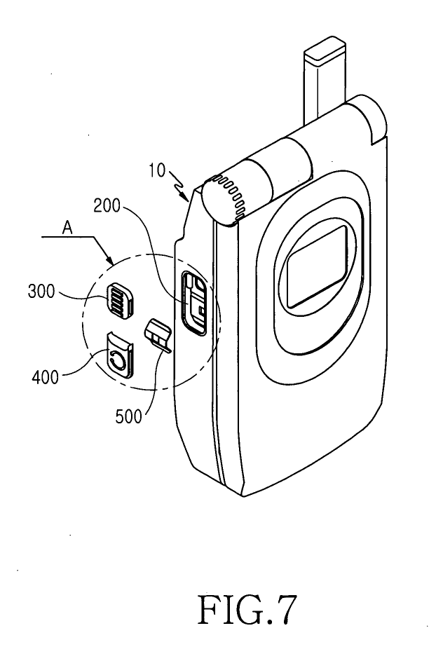

A port cover unit according to a second preferred embodiment of the present invention will be described with reference to FIGS. 7 to 17.

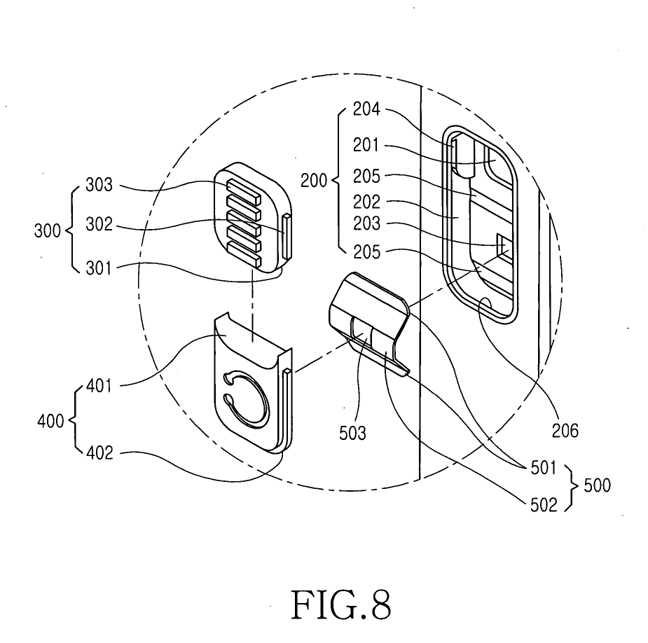

As illustrated in FIGS. 7 and 8, the port cover unit is mounted to an electronic component, for example, a portable communication terminal 10.

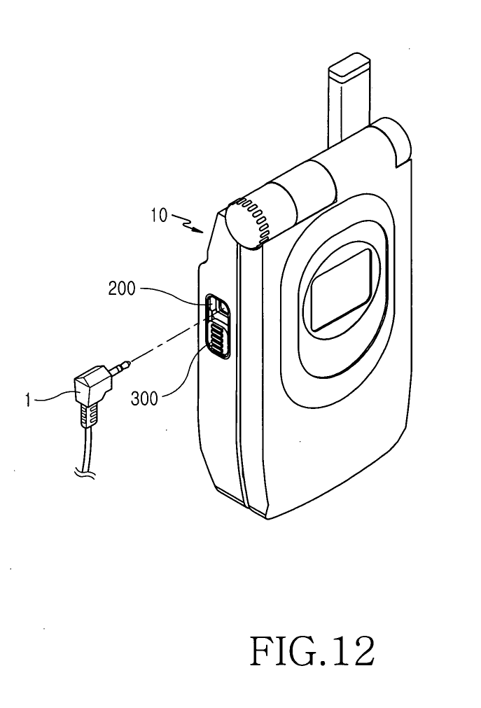

Specifically, the port cover unit of the portable communication terminal 10 is mounted adjacent a port (not shown), such as an ear-microphone jack 1 (shown in FIG. 12), of the portable communication terminal 10.

As illustrated in FIG. 8, the port cover unit has a mounting groove 200, a sliding cover 300, a stationary cover 400, and an elastic member 500. The mounting groove 200 is formed at a predetermined position of the portable communication terminal 10. The mounting groove 200 is provided with a port hole 201.

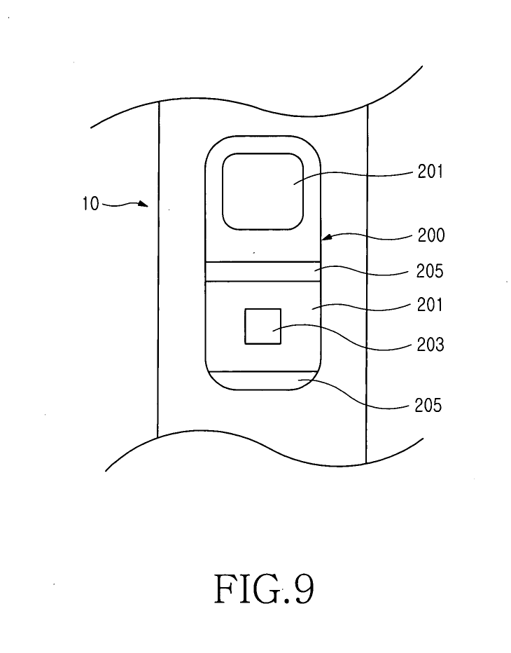

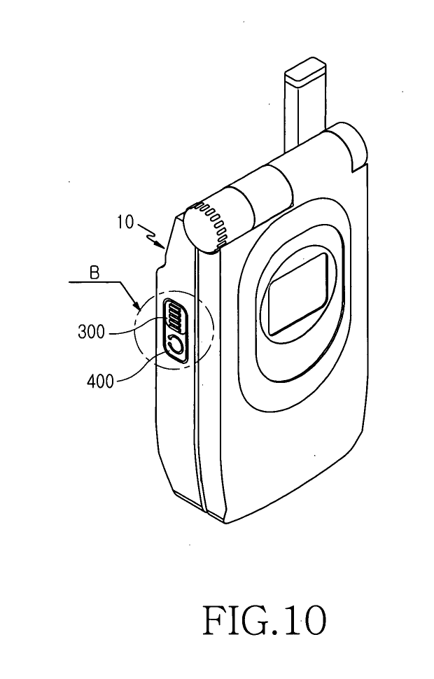

As illustrated in FIGS. 9 and 10, the sliding cover 300 is disposed in the mounting groove 200 and is slidably moveable vertically along a longitudinal direction of the mounting groove 200 so that the port hole 201 is opened and closed.

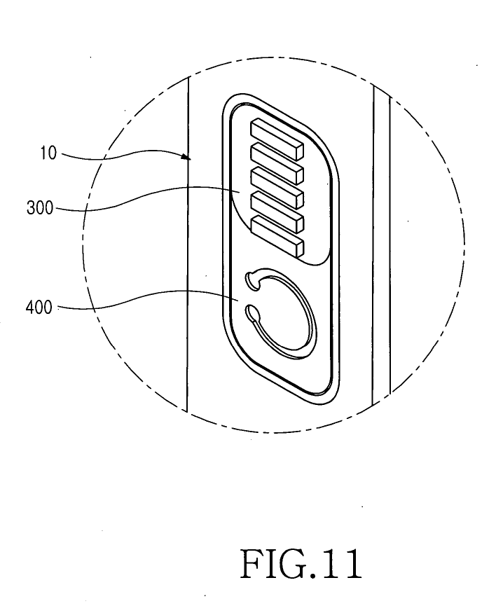

As illustrated in FIG. 11, the stationary cover 400 is disposed at a bottom part of the sliding cover 300 and the stationary cover 400 is aligned with the sliding cover 300 or is placed below the sliding cover 300 depending on the position of the sliding cover 300.

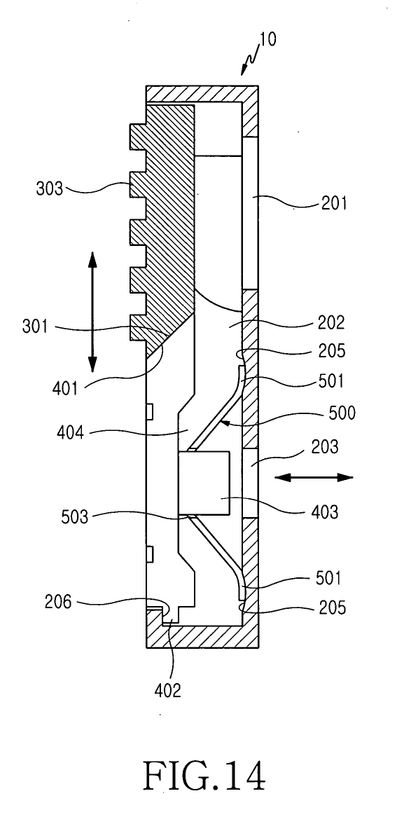

As illustrated in FIG. 14, the elastic member 500 for providing an elastic force is disposed at a rear of the stationary cover 400. The stationary cover 400 is supported by the elastic force when the stationary cover 400 is aligned with the sliding cover 300 or placed below the sliding cover 300 depending on the position of the sliding cover 300. Preferably, the elastic member 500 is a V-shaped spring.

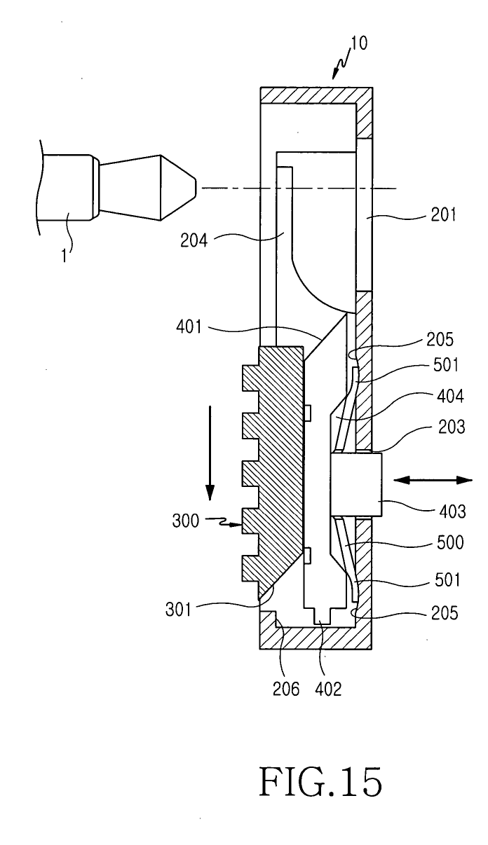

When the port hole 201 is opened, the sliding cover 300 is slidably moved downward, as illustrated in FIGS. 12 and 15. The sliding cover 300 is provided at both sides thereof with guide protrusions 302 (illustrated in FIG. 8), which are engaged with guide rails 204 formed at both sides of the mounting groove 200. The guide protrusions 302 are formed in the longitudinal direction of the sliding cover 300. Thus, the guide protrusions 302 are slidably moved along the guide rails 204, respectively. As a result, the guide protrusions 302 are slidably moved along the corresponding guide rails 204, as illustrated in FIG. 15.

An inclined cover surface 301 of the sliding cover 300 is opposite to an inclined guide surface 401 of the stationary cover 400. Accordingly, the inclined cover surface 301 is guided along the inclined guide surface 401 as the sliding cover 300 is slidably moved.

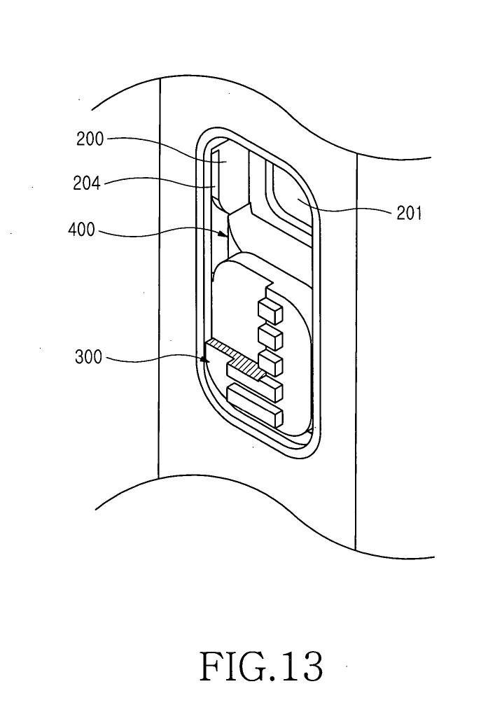

When the sliding cover 300 is completely moved, the stationary cover 400 is placed below the sliding cover 300, and the port hole 201 of the mounting groove 200 is opened, as illustrated in FIG. 13.

The distance between both ends 501 of the elastic member 500, which are provided at a rear of the stationary cover 400, is increased, as illustrated in FIG. 15. Consequently, the ends 501 of the elastic member 500 are engaged into supporting grooves 205 formed at a bottom surface of the mounting groove 200.

As illustrated in FIGS. 14 and 15, the elastic member 500 is provided at the center part 502 thereof with a through-hole 503, through which an insertion protrusion 403 formed at the rear part of the stationary cover 400 is inserted. The insertion protrusion 403 of the stationary cover 400 is inserted through the through-hole 503 of the elastic member 500. As the distance between both ends 501 of the elastic member 500 is increased, the stationary cover 400 is moved into a receiving space 202 defined in the mounting groove 200. Therefore, the insertion protrusion 403 of the stationary cover 400 is inserted into an insertion hole 203 formed in the mounting groove 200.

The ear-microphone jack 1 is inserted through the port hole 201. Thus, the ear-microphone jack 1 is put in the port (not shown) provided in the portable communication terminal 10, as illustrated in FIG. 12.

When the sliding cover 300 is slidably moved upward so that the port hole 201 is closed, the guide protrusions 202 of the sliding cover 300 are moved along the guide rails 204 of the mounting groove 200. The stationary cover 400 is moved outward from the mounting groove 200 by an elastic force of the elastic member 500 provided at the rear of the stationary cover 400, whereby the stationary cover 400 is returned to its original position. The stationary cover 400 is aligned with the sliding cover 300 and thus, the inclined cover surface 301 of the sliding cover 300 is opposite to the inclined guide surface 401 of the stationary cover 400. The stationary cover 400 includes at an outer circumference thereof, a cover protrusion 402, which is caught by a stopper 206 formed in the mounting groove 200. Additionally, the stationary cover 400 includes at the rear part thereof, a supporting groove 404 for supporting the elastic member 500.

The sliding cover 300 includes at the front part thereof, a plurality of knob protrusions 303, by which an external force is transmitted to the sliding cover 300.

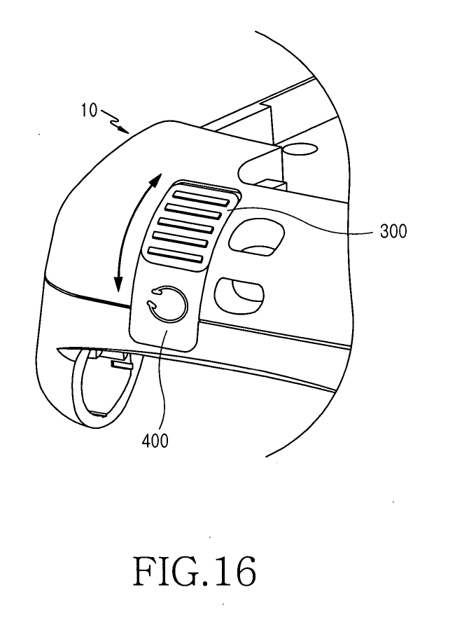

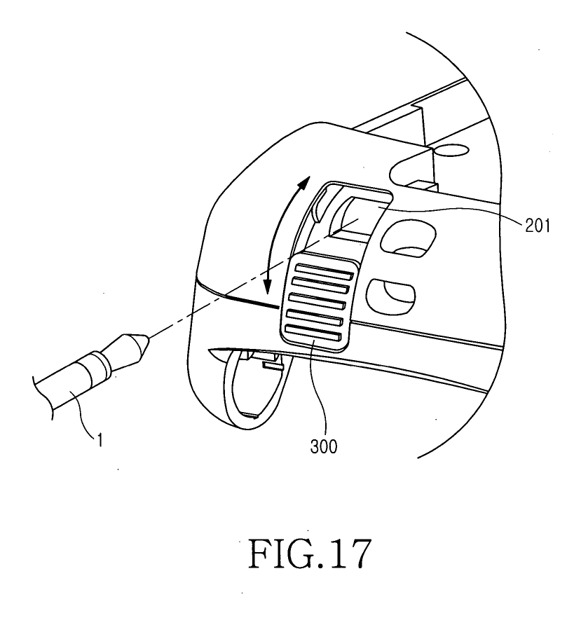

FIGS. 16 and 17 illustrate modifications of the sliding cover 300 and the stationary cover 400. The sliding cover 300 and the stationary cover 400 may be curved when an external appearance of the portable communication terminal 10 is curved. In this case, the sliding cover 300 is slidably moveable and rotatable in a curved line along the curved portable communication terminal 10. As the sliding cover 300 is slidably moved and rotated in the curved line, the stationary cover 400 is placed below the sliding cover 300. Consequently, the port hole 201 is opened.

As apparent from the above description, the port cover unit for electronic equipment can be easily made utilizing injection molding. In other words, the port cover unit can be preferably designed with the same or similar material as that of the portable communication terminal itself. Consequently, aesthetic appearance of the port cover unit is improved. Also, the port cover unit can be easily opened or closed by a simple operation, whereby the opening/closing operation of the port cover unit can be stably accomplished.

Although the preferred embodiment of the present invention has been disclosed for illustrative purposes, those skilled in the art will appreciate that various modifications, additions and substitutions are possible, without departing from the scope and spirit of the invention as disclosed in the accompanying claims. For example, the port cover unit of the present invention may be applied to audio equipment, such as a portable CD (Compact Disk) player, in addition to the portable communication terminal.

1. A port cover unit for protecting at least one port exposed to an outside of an electronic component, the port cover unit comprising:
a cover housing;
a sliding cover slidably attached to an upper end of the cover housing and slidable in a longitudinal direction of the cover housing for partially opening or closing the cover housing; and
a stationary cover attached to the upper end of the cover housing, the stationary cover being aligned with the sliding cover.

2. The unit as set forth in claim 1, further comprising a first inclined surface formed at an end of the sliding cover, and a second inclined surface formed at an end of the stationary cover, the first and second inclined surfaces being opposite to each other, wherein the first inclined surface is placed on the second inclined surface, making contact with the second inclined surface, when the sliding cover is aligned with the stationary cover.

3. The unit as set forth in claim 1, further comprising a cover base attached to the lower end of the cover housing, wherein the cover base is provided at one side thereof with a first opening for exposing the port, and the cover base is provided at the other side thereof with a supporting member for pushing the stationary cover to the upper end of the cover housing.

4. The unit as set forth in claim 3, further comprising a second opening provided at the other side of the cover base and extending in a longitudinal direction of the cover base, and an elastic piece extending from an end of the second opening in a longitudinal direction of the second opening, wherein the supporting member is formed at an end of the elastic piece.

5. The unit as set forth in claim 1, further comprising a first guide rib extending along an upper inside part of the cover housing and protruding inwardly from the cover housing by a predetermined length, and a second guide rib extending along a lower outside part of the sliding cover and protruding outwardly from the sliding cover by a predetermined length, the second guide rib being opposite to the first guide rib.

6. A port cover unit mounted to a region of an electronic component for protecting at least one port exposed to an outside of the electronic component, the port cover unit comprising:
a mounting groove formed at a predetermined region of the electronic component, the mounting groove being provided at an inside thereof with at least one port hole;
a sliding cover disposed in the mounting groove, the sliding cover being slidably moved upward and downward in a longitudinal direction of the mounting groove for opening and closing the port hole;
a stationary cover disposed at a bottom part of the sliding cover, the stationary cover being aligned with the sliding cover and placed below the sliding cover as the sliding cover is moved; and
an elastic member disposed at a rear of the stationary cover for providing an elastic force for supporting the stationary cover when the stationary cover is aligned with the sliding cover and is placed below the sliding cover.

7. The unit as set forth in claim 6, wherein the mounting groove includes a receiving space defined therein for receiving the stationary cover, an insertion hole, into which an insertion protrusion formed at the rear part of the stationary cover is inserted, guide rails, at both sides thereof, respectively, along which the sliding cover is slidably moved, and a stopper, by which the stationary cover is caught.

8. The unit as set forth in claim 6, wherein the sliding cover includes an inclined cover surface, at one end thereof, which is opposite to an inclined guide surface formed on the stationary cover, and guide protrusions, at both sides thereof, which are formed in the longitudinal direction of the sliding cover, the guide protrusions being engaged with guide rails of the mounting groove, respectively.

9. The unit as set forth in claim 6, wherein the stationary cover includes an inclined guide surface at one end thereof, which is opposite to an inclined cover surface of the sliding cover, such that the inclined cover surface of the sliding cover is guided by the inclined guide surface of the stationary cover as the port hole is opened and closed, a cover protrusion, which is caught by a stopper of the mounting groove, an insertion protrusion formed at the rear thereof, the insertion protrusion being inserted through the elastic member, and a supporting groove provided at the rear thereof for supporting the elastic member.

10. The unit as set forth in claim 6, wherein the stationary cover is aligned with the sliding cover while an inclined cover surface of the sliding cover is opposite to an inclined guide surface of the stationary cover when the port hole is closed, and the inclined cover surface of the sliding cover is guided along the inclined guide surface of the stationary cover so that the stationary cover is placed below the sliding cover when the port hole is opened.

11. The unit as set forth in claim 8, wherein the inclined cover surface of the sliding cover and the inclined guide surface of the stationary cover are curved.

12. The unit as set forth in claim 9, wherein the inclined cover surface of the sliding cover and the inclined guide surface of the stationary cover are curved.

13. The unit as set forth in claim 6, wherein the elastic member is a V-shaped spring.

14. The unit as set forth in claim 13, wherein both ends of the V-shaped spring are engaged into supporting grooves formed at a bottom part of the mounting groove, and the V-shaped spring contacts the rear of the stationary cover at a center region thereof.

15. The unit as set forth in claim 13, wherein the V-shaped spring includes a through-hole at center portion thereof, through which an insertion protrusion formed at the rear of the stationary cover is inserted.

16. The unit as set forth in claim 6, wherein the sliding cover and the stationary cover are curved.
